(19) United States
(12) Patent Application Publication
(10) Pub. No.: US 2009/0104867 A1
(43) Pub. Date: Apr. 23, 2009

(54) Building aperture mounted ventilation apparatus

(76) Inventor: John F. Sherman, Williamston, MA (US)

Correspondence Address: John F. Sherman, 1243 North Hoosac Road, Williamston, MA, 01267, US

(21) Appl. No.: 12/288,247

(22) Filed: Oct. 17, 2008

Related U.S. Application Data
(60) Provisional application No. 60/999,573, filed on Oct. 22, 2007.

(51) Int. Cl. E06B 7/02

(52) U.S. Cl. 454/205

(57) ABSTRACT

A ventilation apparatus provides an intermediate space between a building window and the outside the building and provides means for controlling air flow to or from the intermediate space to or from the a building window and the outside of the building. The apparatus can be used in three modes: in one mode for heating air in the interior of the building structure by a circulating flow of air from inside the building, through the intermediate space where it is warmed by captured solar energy, and back into the building interior; in another mode for cooling the interior of the building structure by conveying warm interior air through the intermediate space to outside the building; and in another mode for allowing free two-way ventilation between the interior of the building structure, through the intermediate space, and to and from the outside air.

### CROSS-REFERENCE TO RELATED APPLICATION

This application claims priority based upon my copending Provisional Application Ser. No. 60/999,573; filed Oct. 22, 2007.

### BACKGROUND OF THE INVENTION

1. Field of the Invention

The present invention relates generally to devices for heating by employing solar energy, and, more particularly, to devices especially adapted for use with windows of buildings.

2. Description of the Prior Art

It is well known to use solar energy for heating. More specifically, it is well known to use solar energy capture devices that are associated with windows on buildings.

Throughout the years, a number of innovations have been developed relating to capturing solar energy in conjunction with building windows, and the following U.S. patents are representative of some of those innovations: 4,534,335, 5,081,982, 5,090,302, 5,131,888, and 6,450,414.

More specifically, U.S. Pat. No. 4,534,335 discloses the use of a plurality of hollow fins that provide two functions: insulating an interior; and warming an interior by capturing solar energy. No cooling is provided. Hollow fins are difficult to make and use. In this respect, it would be desirable to provide a solar energy capture device that does not employ a plurality of hollow fins.

U.S. Pat. No. 5,081,982 discloses a device for heating air by capturing solar energy. No cooling features are disclosed.

U.S. Pat. No. 5,090,302 discloses a device to reduce both heat gain and heat loss through windows. Interior building air is drawn by a fan. However, no venting valves are provided to control flow of cooling air or heating air. To obtain reliable flows of heating or cooling air, it would be desirable for a solar energy capture device to have vents and valves that provide accurate control of flows of heating and cooling air.

U.S. Pat. No. 5,131,888 may be of interest for its disclosure of a solar powered exhaust fan that is used for portable buildings. There is no disclosure of its association with window structures.

U.S. Pat. No. 6,450,414 may be of interest for its disclosure of an electronically controlled fan that blows sufficiently warm air from a roof space into the interior space of a building when the air temperature of the roof space exceeds the air temperature of the living space. There is no disclosure of collection of solar energy from a window structure. Also, there is no disclosure of cooling functions.

Still other features would be desirable in a building aperture mounted ventilation apparatus. For example, the prior art discussed above does not provide for cooling functions when it would be desirable to conduct cool air from outside a building to the interior of the building.

In addition, the prior art discussed above, does not provide for two-way ventilation between the interior of a building and the exterior of the building. This would be a desirable feature also.

Finally, it would be desirable for a building aperture mounted ventilation apparatus to provide all of three selectable modes of operation which include heating interior building air by captured solar radiation, directing overly heated building air to outside the building, and permitting two-way ventilation between the interior of a building and outside the building.

Thus, while the foregoing body of prior art indicates it to be well known to use building aperture mounted ventilation apparatuses, the prior art described above does not teach or suggest a building aperture mounted ventilation apparatus which has the following combination of desirable features: (1) provides a solar energy capture device that does not employ a plurality of hollow fins; (2) provides a solar energy capture device which has manually operated vents and valves that provide accurate control of selected flows of heating and cooling air; (3) provides selectable cooling functions when it is desirable to conduct cool air from outside a building to the interior of the building; (4) provides selectable two-way ventilation between the interior of a building and the exterior of the building; and (5) provides all three selectable modes of operation which include heating interior building air by captured solar radiation, directing overly heated building air to outside the building, and permitting two-way ventilation between the interior of a building and outside the building. The foregoing desired characteristics are provided by the unique building aperture mounted ventilation apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a building aperture mounted ventilation apparatus which includes a frame portion that is connected to a building structure. An inside window is connected to the frame portion. A roof portion is connected to the frame portion and projects outward therefrom. Side wall portions are connected to the frame portion and the roof portion. A floor portion is connected to the frame portion and the side wall portions. Outside windows are connected to the side wall portions between the roof portion and the floor portion. A ventilation fan, or plural ventilation fans, are connected to one side of the frame portion, and an air flow vent assembly is connected to another side of the frame portion. In this respect, the present ventilation apparatus provides an intermediate space between a building interior and the outside of the building and provides means for controlling air flow to and from the intermediate space and to and from a building window and the outside of the building.

The apparatus can be used in three modes: in one mode, for heating air in the interior of the building structure by a circulating flow of air from inside the building, through the intermediate space where it is warmed by captured solar energy, and back into the building interior; in another mode for cooling the interior of the building structure by conveying warm interior air through the intermediate space to outside the building; and in another mode for allowing free two-way ventilation between the interior of the building structure via a building window, via the intermediate space, and to and from the outside air.

Preferably, the roof portion is downwardly sloped. Preferably, the outside windows include a first outside window and a second outside window that can be opened and closed with respect each other. The inside window, the side wall portions, the roof portion, the floor portion, and the outside windows define an intermediate space.

More specifically, with one mode of operation of the apparatus of the invention, the ventilation fan and the air flow vent assembly can be used for driving warm air from the intermediate space to the interior of the building structure. With another mode of operation of the apparatus of the invention, the ventilation fan can be used for driving warm air from the interior of the building structure, through the intermediate space, and to outside of the building structure.

A solar electric panel array and an electrical conductor can be electrically connected to the ventilation fans to power them.

In addition, the air flow vent assembly can include frame vent channels in the frame portion and a vent valve plate mounted in the frame portion. The vent valve plate includes valve vent channels. A valve plate control is connected to the vent valve plate, for controlling movement of the vent valve plate with respect to the frame vent channels. A control guide in the frame portion is provided for guiding movement of the valve plate control. By proper operation of venting, air flow can be conducted to and from the intermediate space, to and from the interior of the building, and to and from the outside of the building.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved building aperture mounted ventilation apparatus which has all of the advantages of the prior art and none of the disadvantages.

It is another object of the present invention to provide a new and improved building aperture mounted ventilation apparatus which may be easily and efficiently manufactured and marketed.

It is a further object of the present invention to provide a new and improved building aperture mounted ventilation apparatus which is of durable and reliable construction.

An even further object of the present invention is to provide a new and improved building aperture mounted ventilation apparatus which is susceptible of a low cost of manufacture with regard to both materials and labor, and which accordingly is then susceptible of low prices of sale to the consuming public, thereby making such building aperture mounted ventilation apparatus available to the buying public.

Still yet a further object of the present invention is to provide a new and improved building aperture mounted ventilation apparatus which provides a solar energy capture device that does not employ a plurality of hollow fins.

Still another object of the present invention is to provide a new and improved building aperture mounted ventilation apparatus that provides a solar energy capture device which has manually operated vents and valves that provide accurate control of selected flows of heating and cooling air.

Yet another object of the present invention is to provide a new and improved building aperture mounted ventilation apparatus which provides selectable cooling functions when it is desirable to conduct cool air from outside a building to the interior of the building.

Even another object of the present invention is to provide a new and improved building aperture mounted ventilation apparatus that provides selectable two-way ventilation between the interior of a building and the exterior of the building.

Still a further object of the present invention is to provide a new and improved building aperture mounted ventilation apparatus which provides all three selectable modes of operation which include heating interior building air by captured solar radiation, directing overly heated building air to outside the building, and permitting two-way ventilation between the interior of a building and outside the building.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is an outside plan view showing a preferred embodiment of the building aperture mounted ventilation apparatus of the invention.

FIG. 2 is a side view of the embodiment of the building aperture mounted ventilation apparatus shown in FIG. 1 taken along line 2-2 of FIG. 1.

FIG. 3 is an inside plan view of the embodiment of the building aperture mounted ventilation apparatus of FIG. 2 taken along line 3-3 thereof, wherein the convection air flow vent assembly is in a closed condition.

FIG. 4 is an inside plan view of the bottom portion of the embodiment of the invention shown in FIG. 3, wherein the convection air flow vent assembly is in an open condition.

FIG. 5 is cross-sectional view of the embodiment of the invention shown in FIG. 3, taken along line 5-5, wherein the convection air flow vent assembly is in an open or cooling condition.

FIG. 6 is another cross-sectional view of the embodiment of the invention shown in FIG. 3, wherein the convection air flow vent assembly is in a closed or heating condition.

### DESCRIPTION OF THE PREFERRED EMBODIMENT

With reference to the drawings, a new and improved building aperture mounted ventilation apparatus embodying the principles and concepts of the present invention will be described.

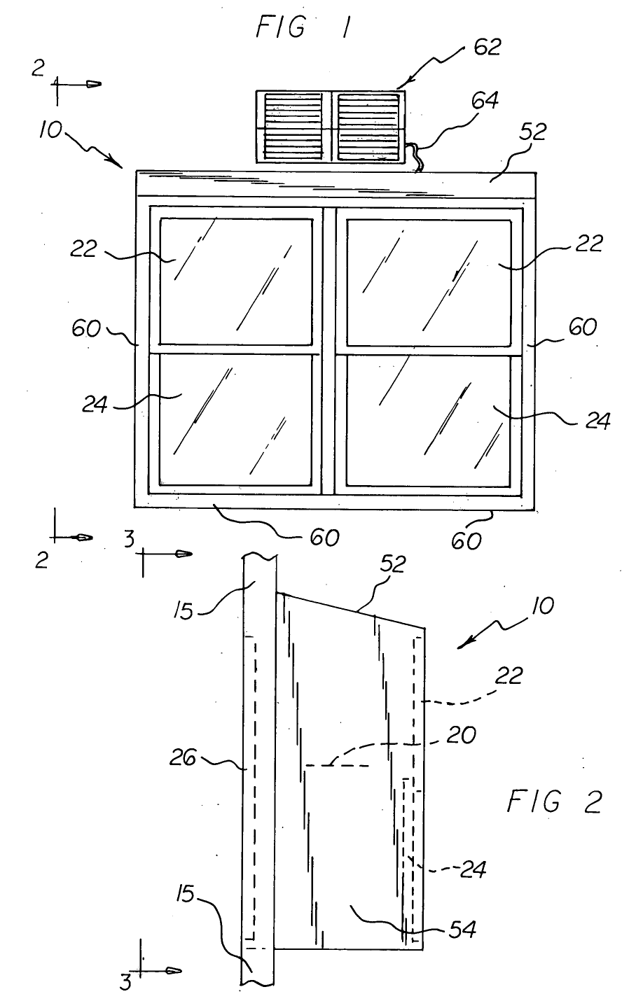

Turning to FIGS. 1-6, there is shown a preferred embodiment of the building aperture mounted ventilation apparatus of the invention generally designated by reference numeral 10. In each of the figures, reference numerals are shown that correspond to like reference numerals that designate like elements shown in other figures.

In the preferred embodiment, building aperture mounted ventilation apparatus 10 includes a frame portion 60 is connected to a building structure 15. An inside window 26 is connected to the frame portion 60. A roof portion 52 is connected to the frame portion 60 and projects outward therefrom. Side wall portions 54 are connected to the frame portion 60 and the roof portion 52. A floor portion 50 is connected to the frame portion 60 and the side wall portions 54. Outside windows are connected to the side wall portions 54 between the roof portion 52 and the floor portion 50. A ventilation fan 30, or plural ventilation fans 30, are connected to one side of the frame portion 60, and an air flow vent assembly 34 is connected to another side of the frame portion 60. The floor portion 50 and the sidewall portions 54 can be painted black to enhance its ability to absorb solar energy rays 13.

Preferably, the roof portion 52 is downwardly sloped. Preferably, the outside windows include a first outside window 22 and a second outside window 24 that can be opened and closed with respect each other. The inside window 26, the side wall portions 54, the roof portion 52, the floor portion 50, and the outside windows define an intermediate space 20.

With one mode of operation of the apparatus of the invention, the ventilation fan 30 and the air flow vent assembly 34 can be used for driving warm air from the intermediate space 20 to the interior of the building structure. With another mode of operation of the apparatus of the invention, the ventilation fan 30 can be used for driving warm air from the interior of the building structure 15, through the intermediate space 20, and to outside of the building structure 15.

A solar electric panel array 62 and an electrical conductor 64 can be electrically connected to the ventilation fans 30 to power them.

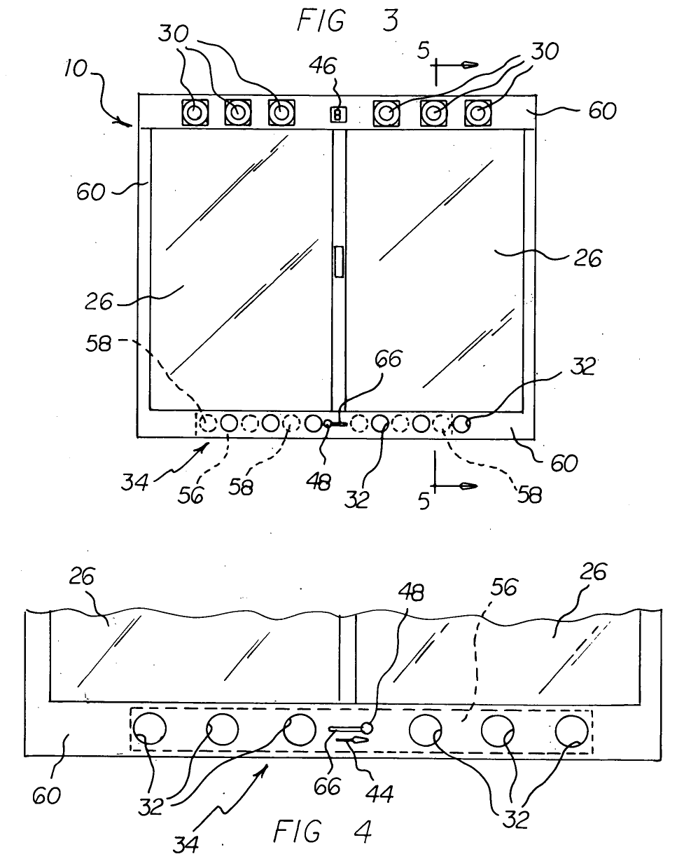

The air flow vent assembly 34 can include frame vent channels 32 in the frame portion 60 and a vent valve plate 56 mounted in the frame portion 60. The vent valve plate 56 includes valve vent channels 58. A valve plate control 48 is connected to the vent valve plate 56, for controlling movement of the vent valve plate 56 with respect to the frame vent channels 32. A control guide 66 in the frame portion 60 is provided for guiding movement of the valve plate control 48. The valve plate control 48 can be valve plate control handle 48, shown in FIGS. 3 and 4.

With the inside window 26 closed, the building aperture mounted ventilation apparatus 10 of the invention can be used in two distinct modes. The first mode is a building interior warming mode, and the second mode is a building interior cooling mode.

Briefly, with the inside window 26 closed, with the building interior warming mode, air in the intermediate space 20 of the apparatus is warmed by solar energy rays 13, and that warmed air is drawn into the interior of the building structure 15. In addition, ventilation fans 30 are used to maintain a flow of air from the interior of the building structure 15, through the intermediate space 20 is warmed by solar energy rays 13, and back into the interior of the building structure 15.

Briefly, with the inside window 26 closed, with the building interior cooling mode, air in the interior of the building structure 15 is blown by the ventilation fans 30 through the intermediate space 20 and out through the outside windows to the exterior of the building structure 15.

More specifically, the building interior warming mode is illustrated in FIGS. 4 and 6. More specifically, the air flow vent assembly 34 is in an open condition The valve plate control handle 48 is operated in the control guide 66 as shown by vent assembly control handle directional arrow 44 so that the valve vent channels 58 in the vent valve plate 56 are in registration with the frame vent channels 32 in the frame portion 60. With this arrangement, air can flow from the interior of the building structure 15 into the intermediate space 20, as shown by building interior to intermediate space air flow directional arrow 40. Also, in the building interior warming mode, the fan directional flow control switch 46 is operated so that the ventilation fans 30 draw in air from the intermediate space 20 to the building interior, as shown by intermediate space to building interior air flow directional arrow 38. Also, in the building interior warming mode, the first outside window 22 and the second outside window 24 are closed with respect to each other so that solar energy rays 13 from the sun 11 enter the intermediate space 20 and warm up the air therein. As shown by the intermediate space to building interior air flow directional arrow 38, air warmed up by the solar energy rays 13 is moved from the intermediate space 20 into the interior of the building structure 15, and, as shown by air flow directional arrow 40, cooler air from the interior of the building is drawn into the intermediate space 20. In this way, air from the interior of the building structure 15 is continuously warmed by the solar energy rays 13 as the air passes continuously from the interior of the building structure 15, through the intermediate space 20, and back into the interior of the building structure 15.

It is noted that the building interior warming mode can operate without the use of the ventilation fans 30 by the use of air convection flow through the intermediate space 20 from the open air flow vent assembly 34 at the bottom of the closed inside window 26, through the intermediate space 20, and through the open ventilation spaces (around unused or absent ventilation fans 30) at the top of the closed inside window 26. However, the rate of air flow through the intermediate space 20 by air convection alone is much less rapid and efficient than with the use of the ventilation fans 30.

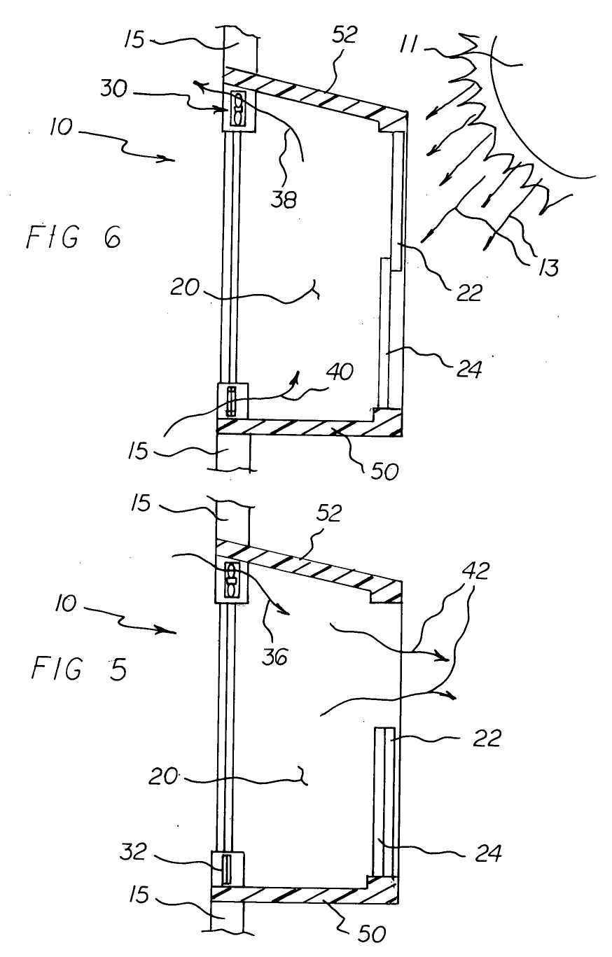

In contrast, with the inside window 26 closed, the building interior cooling mode is conducted as follows, as shown in FIGS. 3 and 5. The first outside window 22 and the second outside window 24 are opened with respect to each other so that air flows out from the intermediate space 20 and to the exterior of the building, as shown by intermediate space to building exterior air flow directional arrows 42. Also, with the building interior cooling mode, the air flow vent assembly 34 is closed. That is, the valve plate control handle 48 is operated in the control guide 66 so that the vent valve plate 56 is moved so that the valve vent channels 58 are not in registration with the frame vent channels 32. Also, with the building interior cooling mode, the fan directional flow control switch 46 is operated so that the ventilation fans 30 operate to draw air out from the interior of the building structure 15 to inside the intermediate space 20 (as shown by building interior to intermediate space fan-driven air flow directional arrow 36) and out from the intermediate space 20 to the exterior of the building (as shown by intermediate space to building exterior air flow directional arrows 42). In this way, warm air from the interior of the building is sent to the exterior of the building structure, thereby cooling the interior of the building structure 15.

Alternatively, if it is desired neither to warm nor to cool the air in the building interior, but it is desired to have a free ventilation flow of air between the inside and the outside of the building structure 15, the inside window 26 can be opened, and the first outside window 22 and the second outside window 24 can be opened with respect to each other. In this way, there will be a direct air flow path from the interior of the building structure 15, through the opened inside window 26, through the intermediate space 20, and through the opened outside windows to the exterior of the building structure 15, and vice versa, without the need for operating either the air flow vent assembly 34 or the ventilation fans 30.

As a further alternative, it may be desired to use the intermediate space 20 as an insulator between the inside window 26 and the outside windows. If this is the case, the air flow vent assembly 34 can be closed, and the ventilation fans 30 can be turned off. In this way, air flow through the intermediate space 20 in any direction would be greatly impeded, and the non-flowing air in the intermediate space 20 can be used for its insulative properties.

It will be understood that the term “building structure” as used herein (and designated by reference sign 15) is to be construed broadly to mean or encompass the house, barn or other dwelling (or part thereof) in which or to which the building aperture mounted ventilation apparatus 10 of the invention is used or attached. The components of the building aperture mounted ventilation apparatus of the invention can be made from inexpensive and durable metal, plastic, wood or glass materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved building aperture mounted ventilation apparatus that is low in cost, relatively simple in design and operation, and which may advantageously be used to provide a solar energy capture device that does not employ a plurality of hollow fins. With the invention, a building aperture mounted ventilation apparatus provides a solar energy capture device which has manually operated vents and valves that provide accurate control of selected flows of heating and cooling air. With the invention, a building aperture mounted ventilation apparatus provides selectable cooling functions when it is desirable to conduct cool air from outside a building to the interior of the building. With the invention, a building aperture mounted ventilation apparatus provides selectable two-way ventilation between the interior of a building and the exterior of the building. With the invention, a building aperture mounted ventilation apparatus provides all three selectable modes of operation which include heating interior building air by captured solar radiation, directing overly heated building air to outside the building, and permitting two-way ventilation between the interior of a building and outside the building.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A building aperture mounted ventilation apparatus, comprising:
a frame portion connected to a building structure,
a inside window connected to said frame portion,
a roof portion connected to said frame portion and projecting outward therefrom,
side wall portions connected to said frame portion and said roof portion,
a floor portion connected to said frame portion and said side wall portions,
an outside window connected to said side wall portions between said roof portion and said floor portion,
a ventilation fan connected to one side of said frame portion, and
an air flow vent assembly connected to another side of said frame portion.
wherein said inside window, said side wall portions, said roof portion, said floor portion, and said outside window define an intermediate space.

2. The apparatus of claim 1 wherein said roof portion is downwardly sloped.

3. The apparatus of claim 1, further including an additional outside window.

4. The apparatus of claim 3 wherein said outside windows include:
a first outside window, and
a second outside window.

5. The apparatus of claim 1 wherein:
said ventilation fan and said air flow vent assembly can be used for driving warm air from said intermediate space to the interior of the building structure, and
said ventilation fan can be used for driving warm air from the interior of the building structure, through the intermediate space, and to outside of the building structure.

6. The apparatus of claim 1, further including:
a solar electric panel array and an electrical conductor electrically connected to said ventilation fan.

7. The apparatus of claim 1 wherein said air flow vent assembly includes:
frame vent channels in said frame portion,
a vent valve plate mounted in said frame portion, wherein said vent valve plate includes valve vent channels,
a valve plate control, connected to said vent valve plate, for controlling movement of said vent valve plate with respect to said frame vent channels, and
a control guide in said frame portion for guiding movement of said valve plate control.
